(19) United States
(12) Patent Application Publication
(10) Pub. No.: US 2026/0074272 A1
(43) Pub. Date: Mar. 12, 2026

(54) ASSEMBLY FOR PRESSURIZATION OF ALL-SOLID-STATE BATTERIES

(71) Applicant: Factorial Inc., Woburn, MA (US)

(72) Inventors: Kwan Li, Reading, MA (US); Srinath Chakravarthy, Glastonbury, CT (US)

(21) Appl. No.: 18/805,626

(22) Filed: Aug. 15, 2024

Related U.S. Application Data
(60) Provisional application No. 63/578,186, filed on Aug. 23, 2023.

(51) Int. Cl. H01M 10/04; H01M 50/105

(52) U.S. Cl. CPC H01M 10/049; H01M 10/0468; H01M 50/105

(57) ABSTRACT

Disclosed is an assembly comprising at least one cell comprising an exterior surface; a bag with an interior surface and an exterior surface, wherein the bag surrounds the at least one cell; an inert gas filling a space between the interior surface of the bag and the exterior surface of the at least one cell; and a casing surrounding the bag, wherein the bag exerts a compressive pressure, via the inert gas, on the at least one cell.

### CROSS-REFERENCE

The present application claims the benefit of U.S. Ser. No. 63/578,186, filed Aug. 23, 2023, the entire content of which is incorporated herein by reference into this application.

### FIELD

This disclosure relates to an assembly for pressurization of all solid-state batteries.

### BACKGROUND

All solid-state batteries undergo a volume expansion or contraction in a range of about 10% to about 30% during its lifetime of operation including during charge or discharge. In order to maintain solid-solid contact between the electrode and solid electrolyte, allow for uniform Lithium deposition and minimize interfacial resistance, a uniform external compressive pressure on the active cell area is usually required. A mechanical fixture, bolts, springs or a combination of several mechanical components could be used to apply the compressive force but may lead to a nonuniform pressure applied to the cell(s). Alternatively, the cell(s) may be sealed in a metal casing filled with a fluid such that the fluid directly contacts the cell and provides a uniform compression. However, the metal case must have sufficient thickness to withstand the compressive forces in addition to allowing the change in volume, which necessitates increasing the thickness of the metal casing, which in turn increases the weight of the casing, which in turn significantly decreases the energy density of the batteries. There remains a need for an assembly that can provide uniform pressure on the cell(s) but without compromising the energy density.

### SUMMARY

Disclosed is an assembly for pressurizing a cell or stack of cells of an all solid-state battery (ASSB). In one embodiment, the assembly comprises: at least one cell comprising an exterior surface; a bag with an interior surface and an exterior surface, wherein the bag surrounds the at least one cell; an inert gas filling a space between the interior surface of the bag and the exterior surface of the at least one cell; and a casing surrounding the bag, wherein the bag exerts a compressive pressure, via the inert gas, on the at least one cell.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1A shows an assembly according to one embodiment of the present disclosure.

FIG. 1B shows an assembly according to one embodiment of the present disclosure.

FIG. 2A shows an assembly according to one embodiment of the present disclosure.

FIG. 2B shows an assembly according to one embodiment of the present disclosure.

FIG. 3A shows a cell/cell stack with two leads according to one embodiment of the present disclosure.

FIG. 3B shows a cell/cell stack with two leads according to one embodiment of the present disclosure.

FIG. 3C shows a cell/cell stack with two leads according to one embodiment of the present disclosure.

FIG. 4A shows a representative configuration of the bag according to one embodiment of the present disclosure.

FIG. 4B shows another representative configuration of the bag according to one embodiment of the present disclosure.

FIG. 5 shows a typical gasket on the bag according to one embodiment of the present disclosure.

FIG. 6 shows a pre-sealing assembly with a lead connected to a gasket on the bag according to one embodiment of the present disclosure.

FIG. 7 illustrates a flow chart showing an assembly method according to one embodiment of the present disclosure.

FIG. 8 shows a bag pre-installed with a gasket according to one embodiment of the present disclosure.

FIG. 9 illustrates a flow chart showing an assembly method according to one embodiment of the present disclosure.

FIG. 10A shows a configuration between the leads and the gasket on the bag according to one embodiment of the present disclosure.

FIG. 10B shows a configuration between the leads and the gasket on the bag according to one embodiment of the present disclosure.

FIG. 11 illustrates a flow chart showing an assembly method according to one embodiment of the present disclosure.

### DETAILED DESCRIPTION

Disclosed is an assembly for pressurizing a cell or stack of cells of an all solid-state battery (ASSB) that provides sufficient compressive pressure on the cell(s) while also maximizing the energy density. In some embodiments, the assembly comprises at least one cell comprising an exterior surface; a bag with an interior surface and an exterior surface, wherein the bag surrounds the at least one cell; an inert gas filling a space between the interior surface of the bag and the exterior surface of the at least one cell; and a casing surrounding the bag, wherein the bag exerts a compressive pressure, via the inert gas, on the at least one cell. In some embodiments, the at least one cell can be enclosed in a pouch to form a pouch cell and the bag exerts a compressive pressure, via the inert gas, on the exterior surface of the pouch cell. The disclosed assembly has the bag exert the compressive pressure on the at least one cell (or pouch cell) instead of the casing so that the pressure is self-contained within the bag and not the casing. This can be advantageous because the weight of the bag needed to contain the pressure may be less than the weight of the casing that would be needed if the pressure were self-contained within the casing, thereby allowing for a higher the energy density of the battery. In some embodiments, the disclosed assembly also allows the bag to act as an insulating layer (which is needed) without the need for an additional insulating layer.

It is to be noted that the transitional term “comprising”, which is synonymous with “including”, “containing” or “characterized by”, is inclusive or open-ended and does not exclude additional, un-recited elements or method steps.

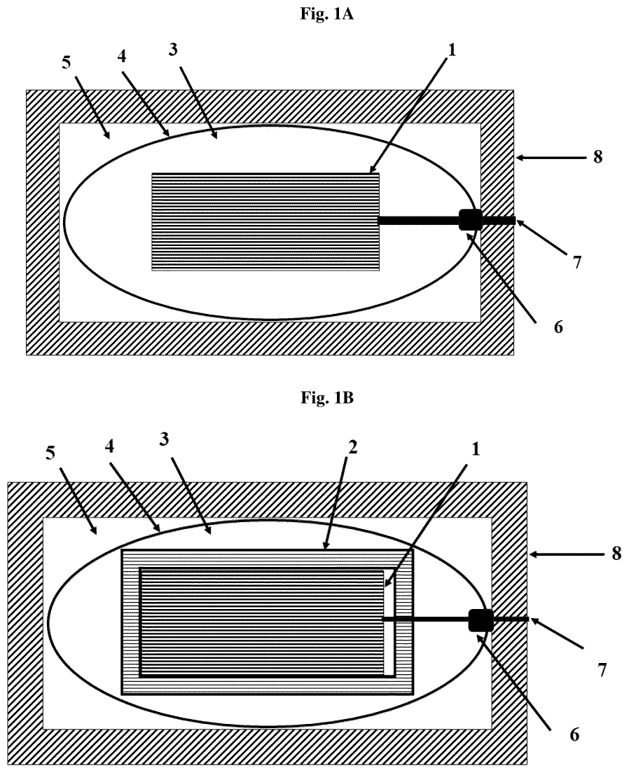

As shown in FIG. 1A, according to some embodiments of the present disclosure, an assembly comprises at least one cell (1) (in this instance multiple cells referred to as a cell stack), a bag (4), a gas (3) filled in a space between the exterior surface of the at least one cell and the interior surface of the bag, a gasket (6) on the bag (4), a casing (8), and one or more electrical leads (7). The electrical leads are electrically connected to one or more external terminals (not shown). In some embodiments, there is a space (5) between the bag (4) and casing (8).

In some embodiments, as shown in FIG. 1A, the at least one cell (1) includes a stack of cells. In other embodiments, pouch cell (2) includes a single cell. In some embodiments, as shown in FIG. 1B, the at least one cell (1) may be enclosed in a pouch (2) to form a pouch cell. In some embodiments, the single cell or the stack of cells includes at least one layer of cathode, at least one layer of anode and at least one layer of a solid electrolyte. In some embodiments, the pouch cell includes a pouch which is airtight. In some embodiments, the pouch is made of a flexible material selected from the group consisting of aluminum foil, aluminum foil with one surface coated with at least one polymer layer, aluminum foil with two surfaces each coated with at least one polymer layer and a combination thereof.

In some embodiments, the bag (4) may exert on cell (1) as shown in FIG. 1A or pouch cell (2) as shown in FIG. 1B, a compressive pressure in a range from 0.1 MPa to 10 MPa, from 0.1 MPa to 9 MPa, from 0.1 MPa to 8 MPa, from 0.1 MPa to 7 MPa, from 0.1 MPa to 6 MPa, from 0.1 MPa to 5 MPa, from 0.1 MPa to 3.5 MPa, from 0.1 MPa to 2 MPa, from 0.1 MPa to 1.5 MPa, from 0.1 MPa to 1 MPa, from 0.2 MPa to 10 MPa, from 0.2 MPa to 9 MPa, from 0.2 MPa to 8 MPa, from 0.2 MPa to 7 MPa, from 0.2 MPa to 6 MPa, from 0.2 MPa to 5 MPa, from 0.2 MPa to 3.5 MPa, from 0.2 MPa to 2 MPa, from 0.2 MPa to 1.5 MPa, from 0.2 MPa to 1 MPa, from 0.35 MPa to 10 MPa, from 0.35 MPa to 9 MPa, from 0.35 MPa to 8 MPa, from 0.35 MPa to 7 MPa, from 0.35 MPa to 6 MPa, from 0.35 MPa to 5 MPa, from 0.35 MPa to 3.5 MPa, from 0.35 MPa to 2 MPa, from 0.35 MPa to 1.5 MPa, from 0.35 MPa to 1 MPa, from 0.5 MPa to 10 MPa, from 0.5 MPa to 9 MPa, from 0.5 MPa to 8 MPa, from 0.5 MPa to 7 MPa, from 0.5 MPa to 6 MPa, from 0.5 MPa to 5 MPa, from 0.5 MPa to 3.5 MPa, from 0.5 MPa to 2 MPa, from 0.5 MPa to 1.5 MPa, from 0.5 MPa to 1 MPa, or any and all ranges and subranges therebetween.

In some embodiments, the bag (4) is made from a material that withstands a volume change of the cell (1) in FIG. 1A or pouch cell (2) in FIG. 1B, which is typically in a range from 10% to 30% or in a range from 5% to 50% such that the bag does not with break or otherwise tear. In some embodiments, the bag is designed to expand to a maximum fixed volume after being filled with the gas. For example, the bag (4) may be a woven polymer. In some embodiments, the woven polymer comprises a polymer and a fiber. In some embodiments, the fiber is a carbon fiber, polymer fiber or a combination thereof. In some embodiments, the fiber is a non-woven fabric or weave. In some embodiments, the fiber is at least one selected from the group consisting of Kevlar, Nomex and Technora. In some embodiments, the bag is thermally insulating.

In some embodiments, the bag (4) has a thickness in a range from 20 μm to 500 μm, from 50 μm to 500 μm, from 75 μm to 500 μm, from 100 μm to 500 μm, from 125 μm to 500 μm, from 150 μm to 500 μm, from 20 μm to 350 μm, from 50 μm to 350 μm, from 75 μm to 350 μm, from 100 μm to 350 μm, from 125 μm to 350 μm, from 150 μm to 350 μm, from 20 μm to 200 μm, from 50 μm to 200 μm, from 75 μm to 200 μm, from 100 μm to 200 μm, from 125 μm to 200 μm, from 150 μm to 200 μm, from 20 μm to 150 μm, from 50 μm to 150 μm, from 75 μm to 150 μm, from 100 μm to 150 μm, from 125 μm to 150 μm, from 20 μm to 100 μm, from 50 μm to 100 μm, from 75 μm to 100 μm, or any and all ranges and subranges therebetween.

In some embodiments, gas (3) may be an inert gas, including but not limited to helium (He), neon (Ne), argon (Ar), krypton (Kr), xenon (Xe), nitrogen (N₂), and mixtures thereof. Use of an inert gas as gas (3) may have the advantage of providing an extra safety feature if a thermal runaway event occurs and the cell catches on fire as the inert gas may suppress the fire.

In some embodiments, the gasket (6) on the bag (4) may be any conventional gasket material with electrically insulating properties. In some embodiments, the lead (7) may extend from the at least one cell (1) as shown in FIG. 1A (or from the pouch cell (2) as shown in FIG. 1B) and through the gasket to connect with a terminal (not shown) on the casing (8) for ultimate connection to an external circuit. In some embodiments, the gasket (6) may be fixed to the lead (7).

In some embodiments, casing (8) may be conventional rigid materials such as Al, Mg, Ti, steel and alloys containing any of the same, fiber-reinforced polymer, and fiber-reinforced composite. In some embodiments, casing (8) has a terminal (to which the lead(s) (7) are connected. The terminal can be any conventional terminals. In some embodiments, a space (5) between the casing (8) and the exterior surface of the bag is occupied by air and allows for the volume change of the bag after it is filled with gas (3) and pressurized. In some embodiments, the space (5) is minimized by a vacuum and this may also provide a thermally insulating effect.

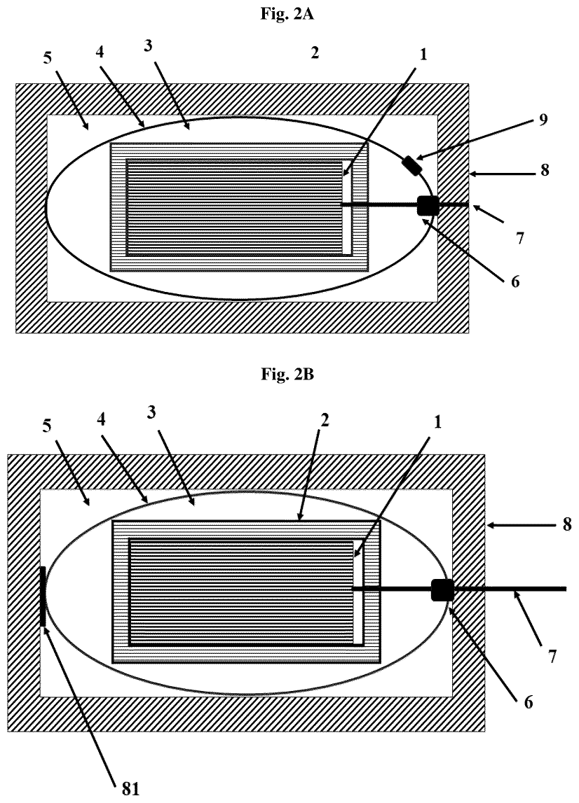

In some embodiments, a valve for injecting and/or releasing the inert gas is installed on the bag. In some embodiments, the valve can be integrated into the gasket (6). In other embodiments, a valve (9) can be separated from the gasket (6) and located at another position on bag (4) as shown for example in FIG. 2A. In some embodiments, the gasket (6) and the value (9), either alone or integrated into a single component, may be located at any section or part of the bag (4).

In some embodiments, the position of the bag (4) in the casing (8) is fixed by attaching the bag to the interior wall of the casing (8). In one embodiment, the bag (4) is physically attached to the casing via a fixing means (81) as shown in FIG. 2B. The fixing means can be a fastener, a welding joint, tie, gluing connection, or a combination thereof. As also shown in FIG. 2B, the electrical leads (7) may extend out of the casing (8).

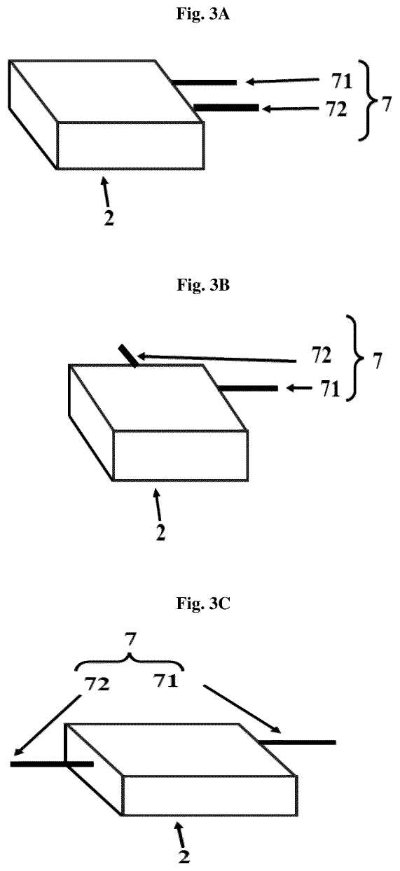

In some embodiments, as shown in FIGS. 3A-3C, the cell/cell stack (2) comprises or is connected to a first lead (71) and a second lead (72) (collectively the lead or leads). The first lead (71) can be electrically connected to anodes or cathodes in the pouch cell (2). The second lead can be electrically connected to cathodes or anodes in the pouch cell (2). The first lead (71) is electrically insulated from the second lead (72).

In one embodiment, the first lead (71) and the second lead (72) are on the same face of the pouch cell as shown in FIG. 3A. In one embodiment, the first lead (71) is on a face adjacent to and perpendicular to the face to which the second lead (72) is connected as shown in FIG. 3B. In one embodiment, the first lead (71) is on a face opposite to the face to which the second lead (72) is connected as shown in FIG. 3C.

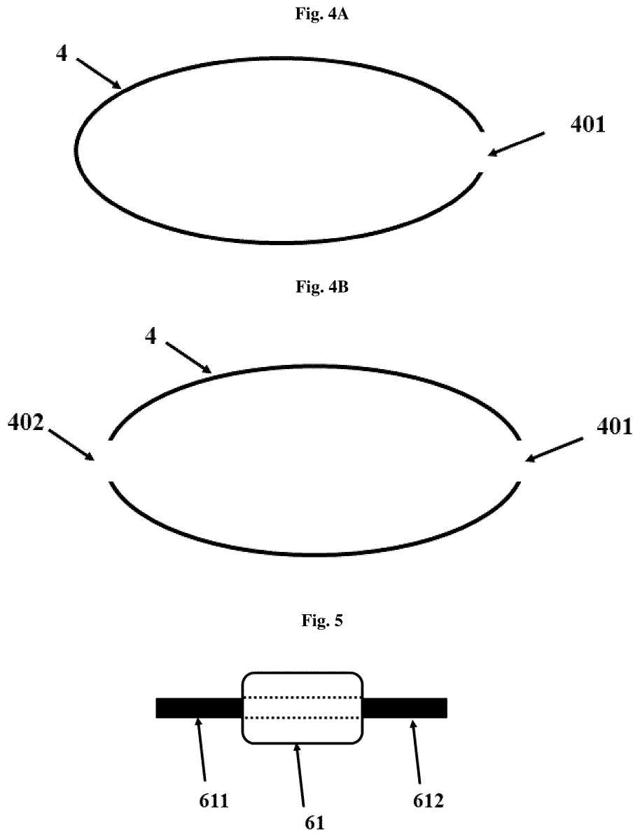

In some embodiments, the bag (4) has one opening (401) as shown in FIG. 4A. In other embodiments, the bag may have a first opening (401) and a second opening (402) as shown in FIG. 4B. In some embodiments, the bag comprises more than two openings, for example to accommodate lead configurations such as those shown in FIGS. 3B and 3C where the leads are not extending from the same side. In one embodiment, the bag (4) is shaped as or like a balloon, cylinder, tube, bladder or a combination thereof.

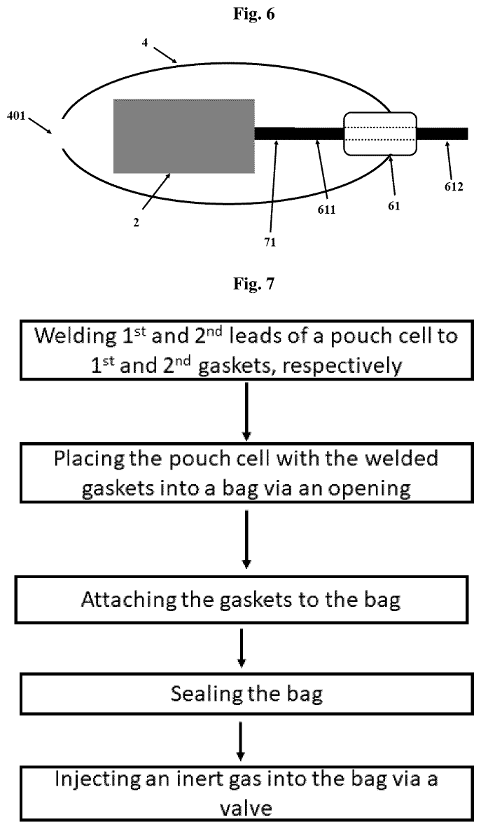

In some embodiments, as shown in FIGS. 5 and 6, gasket (6) from FIG. 1 is a gasket (61) having a first bridge (611) and a second bridge (612) electrically connected to each other. The bag (4) may include one or more gaskets (61). In some embodiments, first bridge (611) of the gasket (61) is inside of the bag (4) while the second bridge (612) thereof is located outside of the bag (4).

In some embodiments, the first bridge (611) of the gasket (61) is attached to the first lead (71) of the pouch cell (2) as shown in FIG. 6. In some embodiments, the first bridge (611) is attached to the first lead (71) by a welding, glue, or any other connecting means that allows or leads to electrical connection therebetween. In some embodiments, where there are multiple leads, for example leads (71) and (72) extending from the pouch cell (2), there may be a separate gasket (61), having a first bridge (611) and a second bridge (612), connected to each lead (71, 72) through first bridge (611). In such embodiments the first bridge (611) of each gasket (61) may be electrically insulated from one another. In some embodiments, the second bridge (612) of gasket(s) (61) may be connected to the terminal on casing (8).

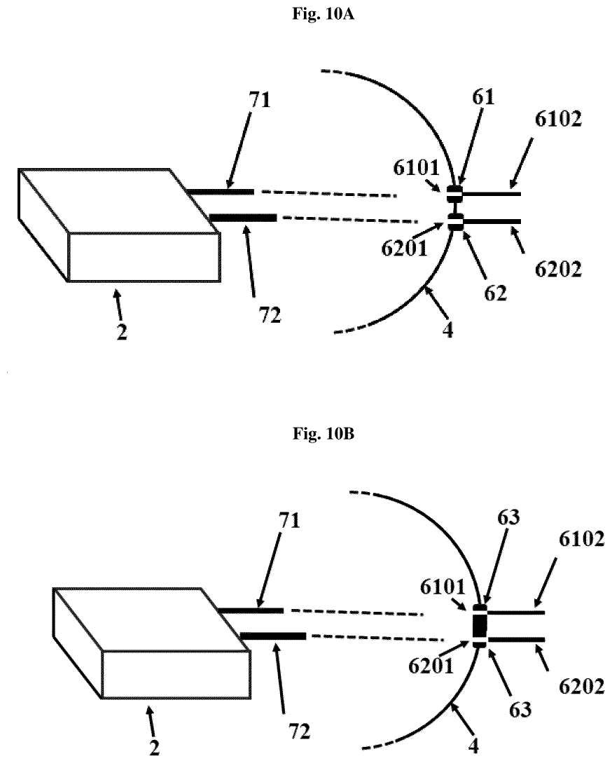

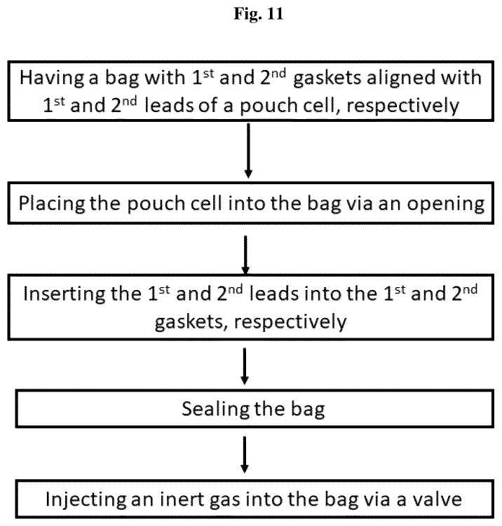

In one aspect, the present disclosure provides a method of preparing an assembly. As exemplarily shown in FIG. 7 according to one embodiment of the present disclosure, the method may comprise the following. A cell assembly may be formed by connecting or attaching (such as welding) the first lead (71) of a cell (1) or pouch cell (2) to a gasket, the second lead (72) of the cell (1) or pouch cell (2) to another gasket. The gasket may be a gasket 61 and first lead (71) may be connected to a first bridge (611) of a first gasket (61) and second lead (72) may be connected to a first bridge (6111) of a second gasket (61). Alternatively, the gaskets may have a socket such as that described below in reference to FIGS. 10A and 10B and the first and second leads may be connected to the gasket(s) by inserting the leads into the sockets. The cell assembly (including the cell (1) or pouch cell (2) with the attached gaskets) may be placed into a bag (4) through opening (401). Then the gaskets may be attached to the bag (4) and the bag sealed. In particular, the opening (401) and the gaskets may be sealed together. The gas, such as an inert gas may be injected into the bag via a valve, wherein the bag (4) exerts a compression, via the inert gas, on the cell (1) or pouch cell (2).

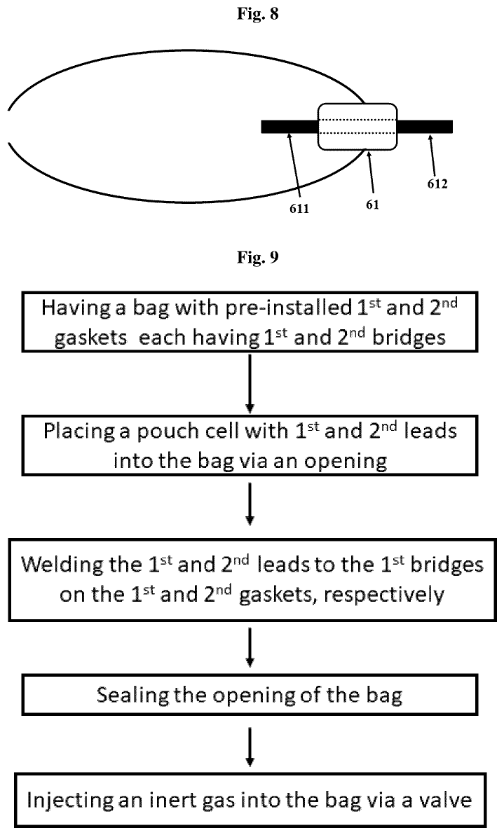

In some embodiments, the bag (4) may be pre-installed with one or more gaskets (61) comprising a first bridge (611) and a second bridge (612) as shown in FIG. 8 (the second gasket not shown).

In one aspect, the present disclosure provides another method of preparing an assembly. As shown exemplarily in FIG. 9, according to one embodiment of the present disclosure, the method may include the following. A bag (4) may be pre-installed with two gaskets (61), wherein each gasket (61) has a first bridge and a second bridge (611 and 612). A cell assembly including either the at least one cell (1) or the pouch cell (2) with first and second leads (71 and 72) may be placed into the bag (4) through opening (401). The first and second leads (71 and 72) may be connected to the gaskets, for example by attaching each of first and second leads (71 and 72) to the first bridge (611) of a gasket (61). The bag (4) may then be sealed, particularly the opening (401) and optionally the gaskets (61) and a gas, such as an inert gas may be injected into the bag via a valve, wherein the bag (4), via the inert gas, exerts a compressive pressure on the cell assembly. In an alternative embodiment, the bag may be flipped inside out to expose the first bridges of the gaskets, the leads connected to the first bridges, and then the bag flipped back to the proper orientation so the cell assembly is within the bag.

In some embodiments, prior to attaching the first and second leads (71 and 72) to the first bridges (611), the method further includes aligning the first and second leads (71 and 72) with the first bridges (611) of the gaskets (61).

According to some embodiments of the present disclosure as shown in FIG. 10A, a gasket (61) on the bag (4) comprises a first socket (6101) aligned with the first lead (71) and a first extension (6102). The first extension (6102) is electrically connected to the first lead (71) once the first lead (71) fits into the first socket (6101) wherein the electrical connection is established by physical touch or connection such as welding. Similarly, a second gasket (62) comprises a second socket (6201) and a second extension (6202), wherein the second socket is aligned with the second lead (72). Once the second lead (72) fits into the second socket (6201), the second lead (72) and the second extension (6202) are electrically connected. The first lead (71) is electrically insulated from the second lead (72) and the second extension (6202). Alternatively, the first gasket (61) may not have first extension (6102) and the second gasket (62) may not have second extension (6202) and in such instances, the first lead (71) may be inserted through and extend out of first socket (6101) and the second lead (72) may be inserted through and extend out of second socket (6201).

In one embodiment, the first gasket (61) is spaced from the second gasket (62) as shown in FIG. 10A. In another embodiment, the first gasket (61) and the second gasket (62) are integrated into a single gasket (63) as shown in FIG. 10B. In such an embodiment, the single gasket (63) is made of an insulative material so that the first lead (71) is electrically insulated from the second lead (72) and the second extension (6202).

In one aspect, the present disclosure provides another method of preparing an assembly. As exemplarily shown in FIG. 11 according to one embodiment of the present disclosure, the method may include the following. The bag (4) may be pre-installed with a first gasket (61) and a second gasket (62), wherein the first gasket (61) comprises a first socket (6101) and a first extension (6102), and the second gasket (62) comprises a second socket (6201) and a second extension (6202). A cell assembly including either the at least one cell (1) or the pouch cell (2) with first and second leads (71 and 72) may be placed into the bag (4) through opening (401). the first and second leads (71 and 72) may be connected to the first and second gaskets (61 and 62) by inserting first and second leads (71 and 72) the first and second sockets (9101 and 9202), respectively. The bag (4) may be sealed, particularly the opening (401) and optionally the gaskets (91 and 92). The gas, for example an inert gas, may be injected into the bag via a valve, wherein the bag (4) exerts, via the inert gas, a compressive pressure on the cell assembly. Alternatively, the first gasket (61) may not have first extension (6102) and the second gasket (62) may not have second extension (6202) and in such instances, the first lead (71) may be inserted through and extend out of first socket (6101) and the second lead (72) may be inserted through and extend out of second socket (6201). The first lead (71) extending out of first socket (6101) is electrically connected to first extension (6102) by physical contact or connection such as welding. The second lead (72) extending out of second socket (6201) is electrically connected to second extension (6202) by physical contact or connection such as welding. Also alternatively, a single gasket (63) having a first socket (6101) and second socket (6201) may be used instead of first and second gasket (61 and 62). In such embodiments, the single gasket (63) may or may not have first extension (6102) and second extension (6202). In some embodiments, the bag may be flipped inside out to expose the gasket(s) (e.g., 61, 62, 63), the leads connected to the gaskets by inserting the leads into sockets (6101 and 6201), and then the bag flipped back to the proper orientation so the cell assembly is within the bag.

In one embodiment, prior to fitting the first and second leads (71 and 72) into the first and second sockets (6101 and 6201), the method further comprises aligning the first and second leads (71 and 72) with the first and second sockets (6101 and 6201), respectively.

In some embodiments, the present disclosure provides an all solid-state battery comprising an assembly as described herein.

### Aspects

In a first aspect, the present disclosure provides an assembly comprising:
at least one cell comprising an exterior surface;
a bag comprising an interior surface and an exterior surface, wherein the bag surrounds the at least one cell;
an inert gas filling a space between the interior surface of the bag and the exterior surface of the at least one cell; and
a casing surrounding the bag, wherein the bag exerts a compressive pressure, via the inert gas, on the at least one cell.

In a second aspect according to the first aspect, the at least one cell comprises a stack of cells.

In a third aspect according to the first or second aspect, the assembly further comprises a pouch encompassing the at least one cell.

In a fourth aspect according to any preceding aspect, the bag comprises a woven polymer.

In a fifth aspect according to any preceding aspect, the at least one cell comprises a first lead and a second lead, which are electrically insulated from each other.

In a sixth aspect according to any preceding aspect, the bag comprises a first gasket and a second gasket.

In a seventh aspect according to any of the first through fifth aspects, the at least one cell comprises a first lead and a second lead, the bag comprises a first gasket and a second gasket, wherein each of the first and second gaskets comprises a first bridge inside of the bag electrically connected to a second bridge outside of the bag, and the first and second leads are connected to the first bridges of the first and second gaskets respectively.

In an eighth aspect according to any of the first through fifth aspects, the at least one cell comprises a first lead and a second lead, and the bag comprises a first gasket and a second gasket, wherein the first gasket comprises a socket that receives the first lead and the second gasket comprises a socket that receives the second lead.

In a nineth aspect according to any of the first through fifth aspects, the at least one cell comprises a first lead and a second lead; and the bag comprises a first gasket having a first socket that receives the first lead and a second gasket having a second socket that receives the second lead.

In a tenth aspect according to any preceding aspect, the bag withstands a volume change of the at least one cell in a range from 10% to 30%.

In an eleventh aspect according to any preceding aspect, the compressive pressure is in a range from 0.1 MPa to 10 MPa.

In a twelfth aspect according to any preceding aspect, wherein the inert gas is selected from the group consisting of He, Ne, Ar, Kr, Xe, N₂, and mixtures thereof.

In a thirteenth aspect according to any preceding aspect, the bag is made of a material that allows inflation, deflation, or both.

In a fourteenth aspect, the present disclosure provides an all solid-state battery comprising the assembly according to any preceding aspect.

In a fifth aspect, the present disclosure provides a method of preparing an assembly. The method comprises:
a) placing a cell assembly into an opening of a bag, wherein the cell assembly comprises at least one cell, a first lead extending from the at least one cell and connected to a first gasket, and a second lead extending from the at least one cell and connected to a second gasket; ;
b) attaching the first and second gaskets to the bag;
c) sealing the bag; and
d) injecting a gas into the bag, thus obtaining the assembly, wherein the bag exerts, via the gas, a compressive pressure on the at the at least one cell.

In a sixteenth aspect according to the fifteenth aspect, the first gasket comprises a first bridge and a second bridge extending therefrom; wherein the second gasket comprises a first bridge and a second bridge extending therefrom; and wherein the first lead is connected to the first bridge of the first gasket and the second lead is connected to the first bridge of the second gasket.

In a seventeenth aspect according to the fifteenth aspect, the first gasket comprises a socket; the second gasket comprises a socket; and wherein the first lead is inserted into the socket of the first gasket and the second lead is inserted into the socket of the second gasket.

In an eighteenth aspect, the present disclosure provides a method of preparing an assembly. The method comprises:
a) placing a cell assembly into an opening of a bag, wherein the cell assembly comprises at least one cell, a first lead extending from the at least one cell, and a second lead extending from the at least one cell, and wherein the bag comprises a first gasket and a second gasket;
b) connecting the first and second leads of the at least one to the first and second gaskets, respectively;
c) sealing the bag;
d) injecting a gas into the bag, thus obtaining the assembly, wherein the bag exerts, via the gas, a compressive pressure on the at least one cell.

In a nineteenth aspect according to the eighteenth aspect, the first gasket comprises a first bridge located in the bag and a second bridge extending from the bag; wherein the second gasket comprises a first bridge located in the bag and a second bridge extending from the bag; and wherein connecting the first and second leads to the first and second gaskets, respectively, comprises attaching the first lead to the first bridge of the first gasket and the second lead to the first bridge of the second gasket.

In a twentieth aspect according to the eighteenth aspect, the first gasket comprises a socket; wherein the second gasket comprises a socket; and wherein connecting the first and second leads to the first and second gaskets, respectively, comprises inserting the first lead into the socket of the first gasket and inserting the second lead into the socket of the second gasket.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

We claim:

1. An assembly comprising:
at least one cell comprising an exterior surface;
a bag comprising an interior surface and an exterior surface, wherein the bag surrounds the at least one cell;
an inert gas filling a space between the interior surface of the bag and the exterior surface of the at least one cell; and
a casing surrounding the bag, wherein the bag exerts a compressive pressure, via the inert gas, on the at least one cell.

2. The assembly of claim 1, wherein the at least one cell comprises a stack of cells.

3. The assembly of claim 1, further comprising a pouch encompassing the at least one cell.

4. The assembly of claim 1, wherein the bag comprises a woven polymer.

5. The assembly of claim 1, wherein the at least one cell comprises a first lead and a second lead, which are electrically insulated from each other.

6. The assembly of claim 1, wherein the bag comprises a first gasket and a second gasket.

7. The assembly of any of claim 1, wherein the at least one cell comprises a first lead and a second lead, the bag comprises a first gasket and a second gasket, wherein each of the first and second gaskets comprises a first bridge inside of the bag electrically connected to a second bridge outside of the bag, and the first and second leads are connected to the first bridges of the first and second gaskets respectively.

8. The assembly of claim 1, wherein the at least one cell comprises a first lead and a second lead, the bag comprises a first gasket and a second gasket, and the first gasket comprises a socket that receives the first lead and the second gasket comprises a socket that receives the second lead.

9. The assembly of claim 1, wherein the at least one cell comprises a first lead and a second lead; and the bag comprises a first gasket having a first socket that receives the first lead and a second gasket having a second socket that receives the second lead.

10. The assembly of claim 1, wherein the bag withstands a volume change of the at least one cell in a range from 10% to 30%.

11. The assembly of claim 1, wherein the compressive pressure is in a range from 0.1 MPa to 10 MPa.

12. The assembly of claim 1, wherein the inert gas is selected from the group consisting of He, Ne, Ar, Kr, Xe, N₂, and mixtures thereof.

13. The assembly of claim 1, wherein the bag is made of a material that allows inflation, deflation, or both.

14. An all solid-state battery comprising the assembly of claim 1.

15. A method of preparing an assembly, comprising:
a) placing a cell assembly into an opening of a bag, wherein the cell assembly comprises at least one cell, a first lead extending from the at least one cell and connected to a first gasket, and a second lead extending from the at least one cell and connected to a second gasket;
b) attaching the first and second gaskets to the bag;
c) sealing the bag; and
d) injecting a gas into the bag, thus obtaining the assembly, wherein the bag exerts, via the gas, a compressive pressure on the at the at least one cell.

16. The method of claim 15, wherein the first gasket comprises a first bridge and a second bridge extending therefrom; wherein the second gasket comprises a first bridge and a second bridge extending therefrom; and wherein the first lead is connected to the first bridge of the first gasket and the second lead is connected to the first bridge of the second gasket.

17. The method of claim 15, wherein the first gasket comprises a socket, the second gasket comprises a socket; and the first lead is inserted into the socket of the first gasket and the second lead is inserted into the socket of the second gasket.

18. A method of preparing an assembly, comprising:
a) placing a cell assembly into an opening of a bag, wherein the cell assembly comprises at least one cell, a first lead extending from the at least one cell, and a second lead extending from the at least one cell, and wherein the bag comprises a first gasket and a second gasket;
b) connecting the first and second leads of the at least one to the first and second gaskets, respectively;
c) sealing the bag;
d) injecting a gas into the bag, thus obtaining the assembly, wherein the bag exerts, via the gas, a compressive pressure on the at least one cell.

19. The method of claim 18, wherein the first gasket comprises a first bridge located in the bag and a second bridge extending from the bag; wherein the second gasket comprises a first bridge located in the bag and a second bridge extending from the bag; and wherein connecting the first and second leads to the first and second gaskets, respectively, comprises attaching the first lead to the first bridge of the first gasket and the second lead to the first bridge of the second gasket.

20. The method of claim 18, wherein the first gasket comprises a socket; wherein the second gasket comprises a socket; and wherein connecting the first and second leads to the first and second gaskets, respectively, comprises inserting the first lead into the socket of the first gasket and inserting the second lead into the socket of the second gasket.
